(19) United States
(12) Patent Application Publication
(10) Pub. No.: US 2015/0158151 A1
(43) Pub. Date: Jun. 11, 2015

(54) RATCHET ADJUSTABLE LOCKING PLIERS

(71) Applicant: CURTIS BROWN, AUSTIN, TX (US)

(72) Inventor: CURTIS BROWN, AUSTIN, TX (US)

(21) Appl. No.: 14/529,143

(22) Filed: Oct. 30, 2014

Related U.S. Application Data
(60) Provisional application No. 61/899,037, filed on Nov. 1, 2013.

(51) Int. Cl. B25B 7/18; B25B 7/14

(52) U.S. Cl. CPC B25B 7/18; B25B 7/14

(57) ABSTRACT

This invention relates generally to pliers, and more particularly to releasably locking pliers having a ratchet mechanism for adjusting the pliers' upper and lower jaws about an item to be gripped there-between. The ratchet mechanism facilitates an incremental adjustment of the pliers' jaws.

### CROSS REFERENCE TO RELATED APPLICATIONS

Thus application claims priority to U.S. Provisional Application Ser. No. 61/899,037 filed on Nov. 1, 2013.

### TECHNICAL FIELD OF THE INVENTION

This invention relates generally to pliers, and more particularly to releasably locking pliers having a ratchet mechanism for adjusting the pliers' upper and lower jaws about an item to be gripped there-between.

### BACKGROUND OF THE INVENTION

Locking pliers are utilized to grip a work-piece between the pliers' jaws and thereafter lock the work-piece there-between. Prior art locking pliers typically require that the jaws be adjusted, via the rotation of a knob, to approximate both the size of the jaw opening and jaw gripping pressure in relation to the work-piece to be gripped therein. Such locking pliers are tedious to use in that effort is required to repeatedly size and grip the work-piece within the jaws and thereafter rotate the knob until the desired jaw opening and locking pressure is achieved.

Self adjusting, locking pliers are present in the prior art to readily adjust the jaw opening to the size of the work-piece to be gripped therein. However, such pliers are imprecise in the adjustment of the jaws in relation to the work-piece. More specifically, squeezing the pliers' handles sweep the jaws towards one another about the work-piece without any incremental control of the jaw's sweep or closing operation.

The present invention overcomes the foregoing disadvantages by providing a self-adjusting, locking plies that readily adjusts the jaw opening to the size of the work-piece to be gripped therein while allowing for an incremental control of such adjustment.

### SUMMARY OF THE INVENTION

This invention relates generally to pliers, and more particularly to releasably locking pliers having a ratchet mechanism for adjusting the pliers' upper and lower jaws about an item to be gripped there-between. The ratchet mechanism facilitates an incremental adjustment of the pliers' jaws. In one embodiment, the pliers comprise a lower handle defining forward and rearward ends. A release mechanism and lower pawl are operably associated with the lower handle, and an upper pawl is operably associated with the release mechanism. A lower jaw defines an arcuate outer surface and is operably associated with the upper and lower pawls. An upper member defines an upper handle and upper jaw, with the upper member operably associated with the lower jaw and the upper handle operably associated with the lower handle.

In another embodiment, the an adjustment mechanism adjustably operably associates the upper member and lower handle for adjusting the pressure between the upper and lower jaws and for providing the locking function of the pliers.

### BRIEF DESCRIPTION OF THE DRAWINGS

FIG. 1 illustrates an exploded assembly view of one embodiment of the pliers;

FIG. 2 illustrates the assembled pliers of FIG. 1;

FIG. 3A illustrates an exploded assembly view of one embodiment of the adjustment mechanism of the pliers;

FIG. 3B illustrates an exploded assembly view an alternate embodiment of the adjustment mechanism of the pliers;

FIG. 4 illustrates one embodiment of the pliers' lower pawl;

FIG. 5 illustrates one embodiment of the pliers' upper pawl; and

FIG. 6 illustrates one embodiment of the pliers' upper pawl spring.

### DESCRIPTION OF THE EMBODIMENTS

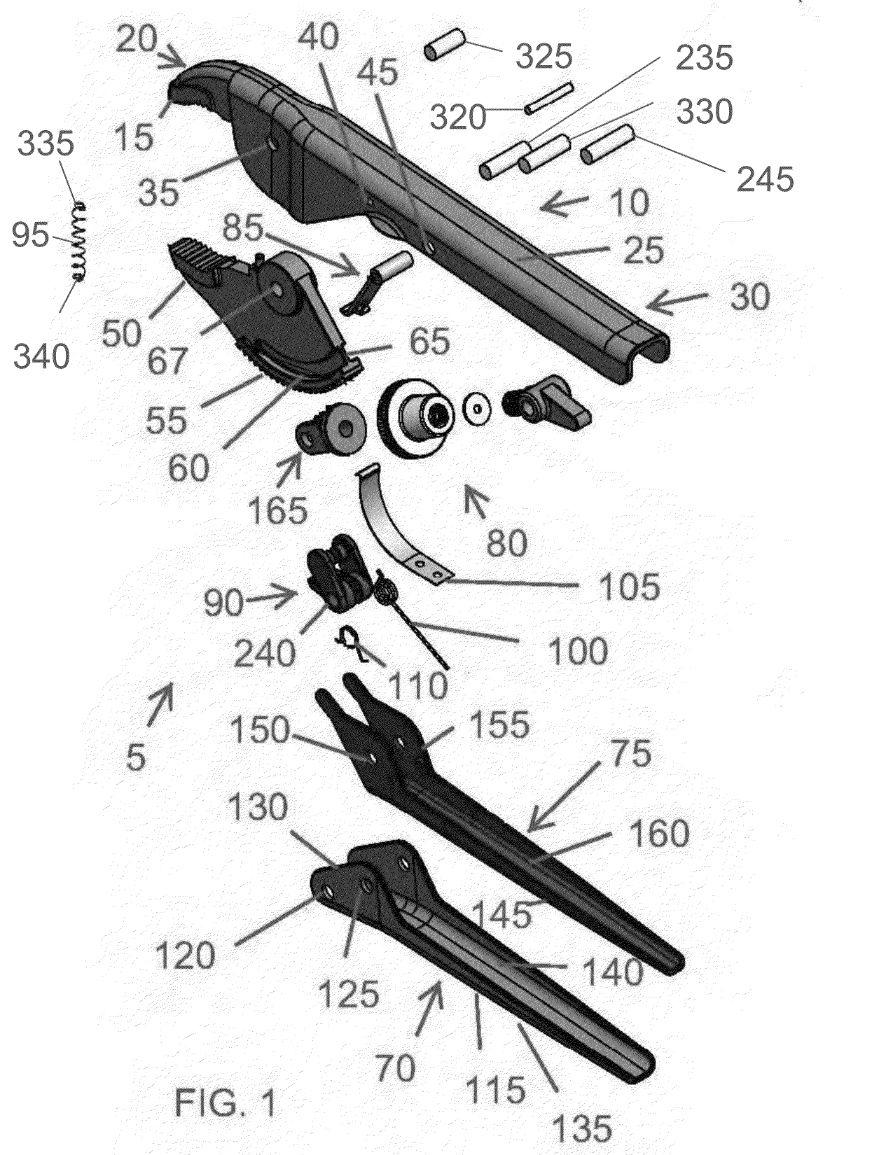

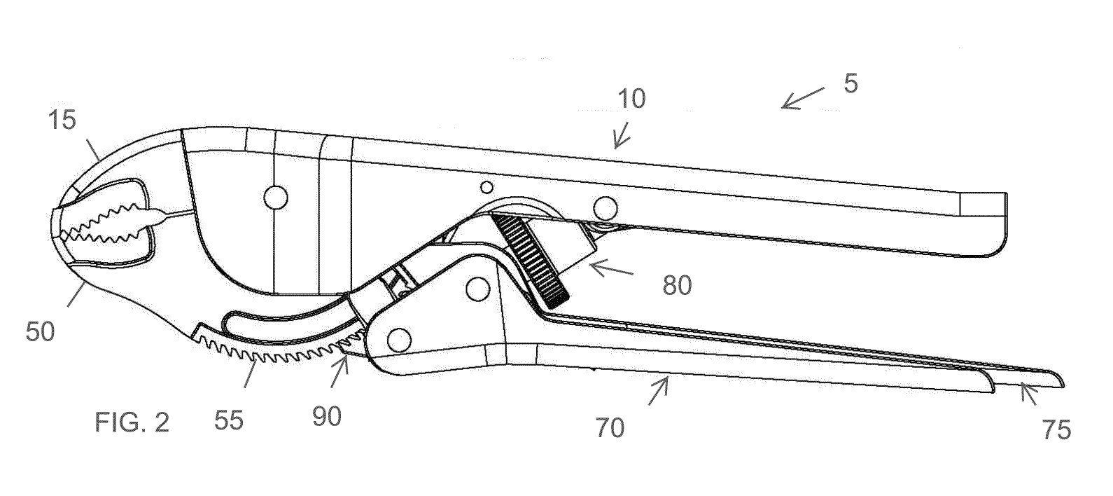

FIGS. 1 and 2 illustrate the basic components of one embodiment of the ratchet adjustable locking pliers 5. As illustrated therein, the pliers 5 comprises an elongated upper body 10 defining an upper jaw 15 at a first end 20, an upper handle 25 at a second end 30 thereof, and first, second and third through bores 35, 40 and 45 therein. The pliers further comprises a lower jaw 50 defining an arcuate toothed outer surface 55, a pair of engagement grooves 60 and 65, and a bore 67, with the lower jaw pivotally connected by its bore to the upper jaw at through bore 35 and influenced by the lower handle 70. A handle release mechanism 75 is operably associated with the lower handle 70 to release the handle's influence from the lower jaw 50.

An adjustment mechanism 80 is operably adjustable between the upper body 10 and lower handle 75 to adjust the gripping pressure exerted between the pliers' upper and lower jaws 15 and 50. Upper and lower pawls 85 and 90, operably connected between the upper body 10, lower handle 70 and release mechanism 75, each engage the arcuate toothed surface 55 defined on the pliers' lower jaw 50. The pawls establish a ratchet mechanism that facilitates an incremental adjustment of the pliers' jaws. The pliers 5 further comprises a jaw release spring 95, a lower handle spring 100, and upper and lower pawl springs 105 and 110. The pliers further comprises a plurality of pins, each pin to be further discussed, for holding the foregoing components together as an assembly.

The lower handle 70 of the pliers 5 comprises an elongated member 115 having first and second through bores 120 and 125 defined proximal to a forward end 130 of the member, a gripping surface 135 and an interior portion 140 adapted to accept the handle release mechanism therein. The handle release mechanism 75, comprising a further elongated member 145 adapted to fit within the interior 140 of the lower handle 70, defines a through bore 150 proximal to a first end 155 thereof and a release interior portion 160 adapted to accept a thumbnut pivot 165 of the adjustment mechanism 80 therein.

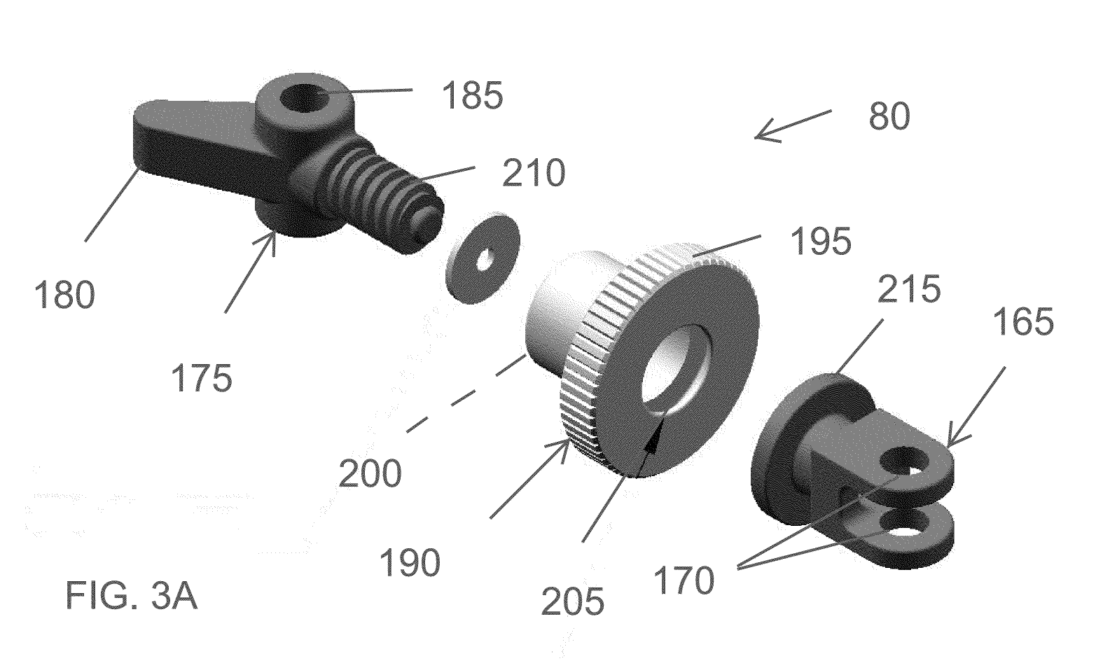

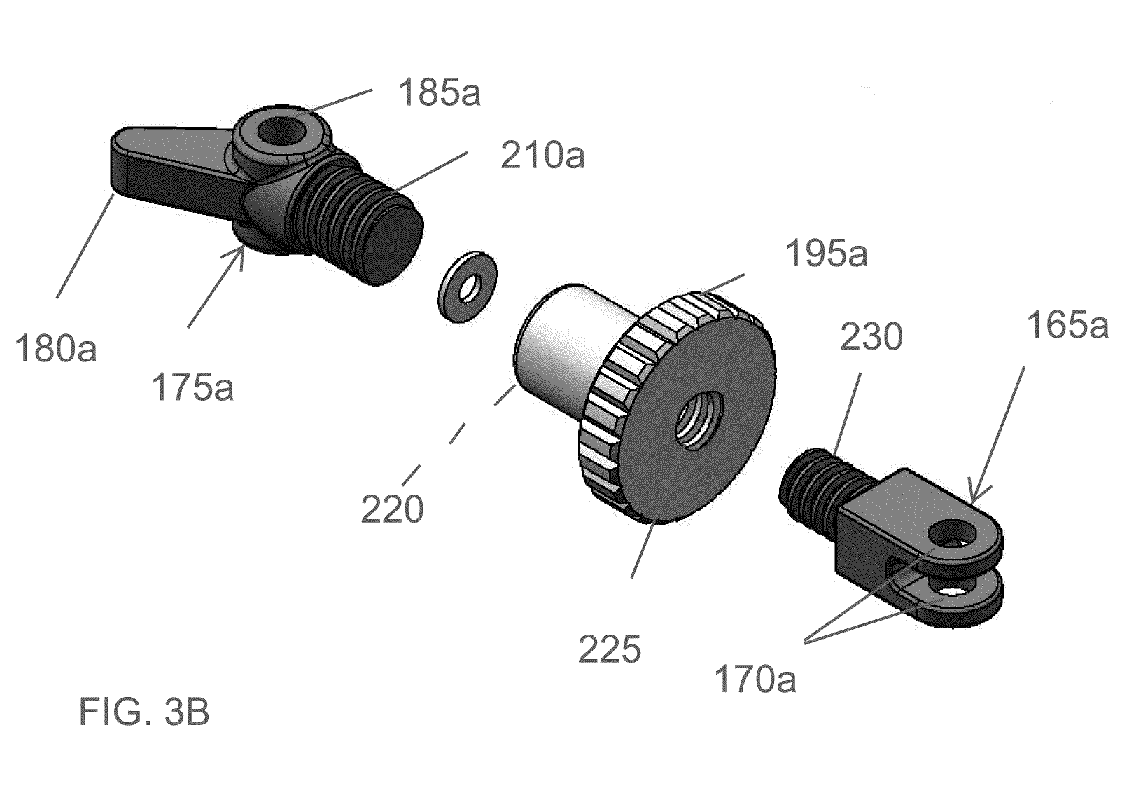

Referring to FIG. 3A, the adjustment mechanism 80 comprises the thumbnut pivot 165 defining a pivot through bore 170 and a linkage adjuster 175 defining a tail 180 and tail through bore 185. Both the thumbnut pivot and linkage adjuster are operably associated with a linkage thumbnut 190 located there-between. The linkage thumbnut 190 comprises a cylindrical toroid 195 defining inner an inner thread 200 and inner circular contact surface 205. The thumbnut's inner thread 200 engages an outer thread 210 defined on the linkage adjuster 175 white its inner circular contact surface 205 engages a perimeter contact surface 215 defined on the thumbnut pivot 165.

Referring to FIG. 3B, another embodiment of the adjustment mechanism 80 comprises the thumbnut pivot 165a defining a pivot through bore 170a and a linkage adjuster 175a defining a tail 180a and tail through bore 185a. Both the thumbnut pivot and linkage adjuster are operably associated with a linkage thumbnut 90a located there-between. The linkage thumbnut 190a comprises a cylindrical toroid 195 defining first and second inner threads 220 and 225. The thumbnut's first inner thread 220 engages an outer thread 210a defined on the linkage adjuster 175a while its second inner thread 225 engages an outer thread 230 defined on the thumbnut pivot 165a.

Referring again to FIGS. 1 and 2, the handle release mechanism 75 is located within the interior 140 of the lower handle 70, with the release mechanism and lower handle pivotally connected to one another about a pin 235 inserted through both the lower handle's second through bore 125 and the release mechanism's through bore 150. The pin 235 pivotally connecting the lower handle 70 and release mechanism 75 to one another, via its insertion through the through respective bores 125 and 150, also pivotally connects the thumbnut pivot 170 or 170a of the adjustment mechanism to both the lower handle and release mechanism via its insertion through the pivot's through bore 165 or 165a. The lower handle spring 100, preferably comprising a torsion spring located about pin 235, spring biases the tower handle 70 and release mechanism 75 in an extended position against the adjustment mechanism 80 such that the lower handle is biased away from the upper handle.

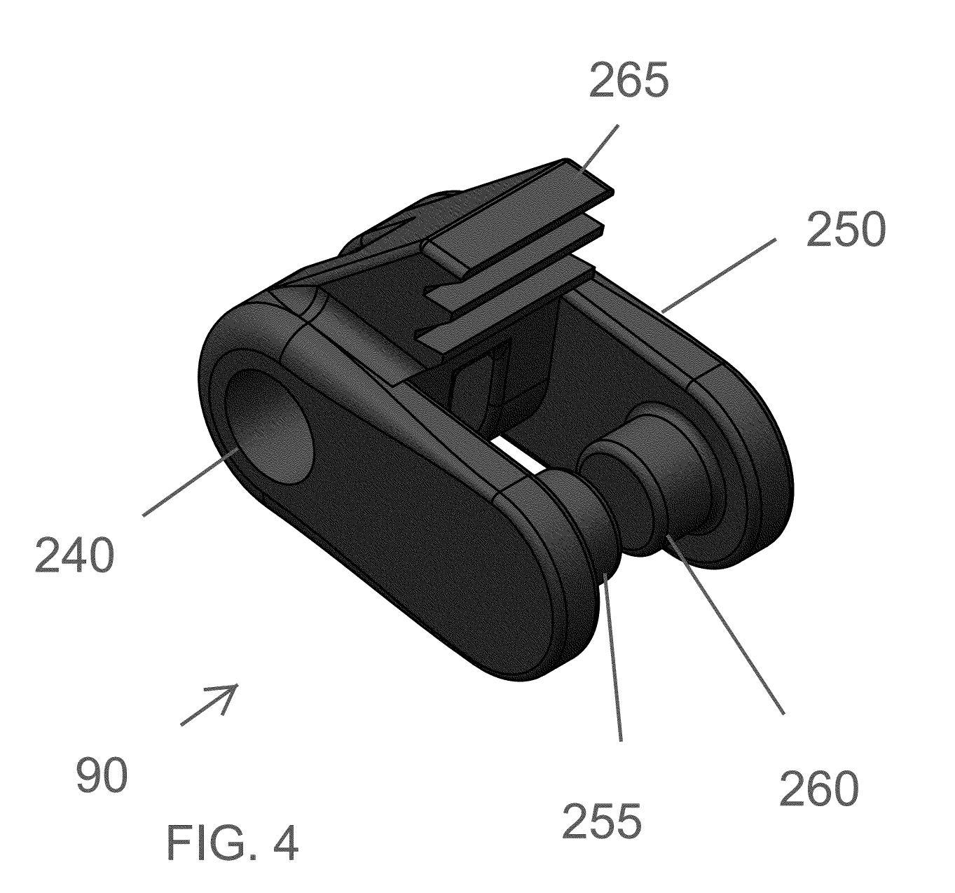

The lower handle's first through bore 120 is axially aligned with a through bore 240 defined in the lower pawl 90 such that the lower handle 70 and lower pawl are pivotally connected to one another via the insertion of pin 245 through the respective through bores 120 and 240. Referring to FIG. 4, the lower pawl 90 comprises a bifurcated flange 250 defining the through bore 240, a pair of interiorly-directed engagement pins 255 and 260 and a plurality of pawl teeth 265. With the engagement pin 245 pivotally connecting the lower pawl 90 to the lower handle 70, the teeth 265 of the lower pawl extend forwardly of the lower handle for engagement with the lower jaw's arcuate toothed surface 55 while the engagement pins are located forwardly of the lower handle for engagement with the lower jaw's respective arcuate grooves 60 and 65, to be further discussed. The lower pawl spring 110 (FIG. 1), preferably comprising a torsion spring located about pin 245, spring biases the lower pawl's teeth 265 against the arcuate toothed surface 55 of the pliers' lower jaw 50.

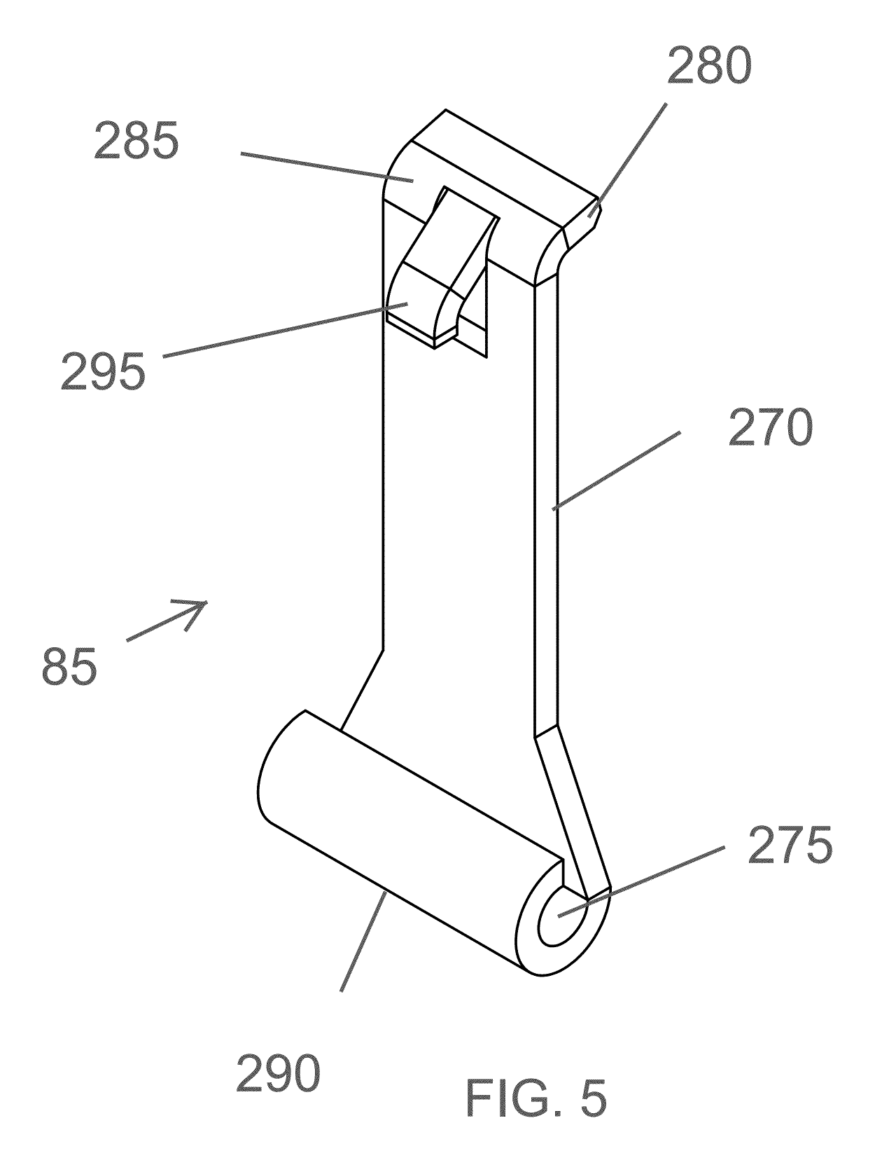

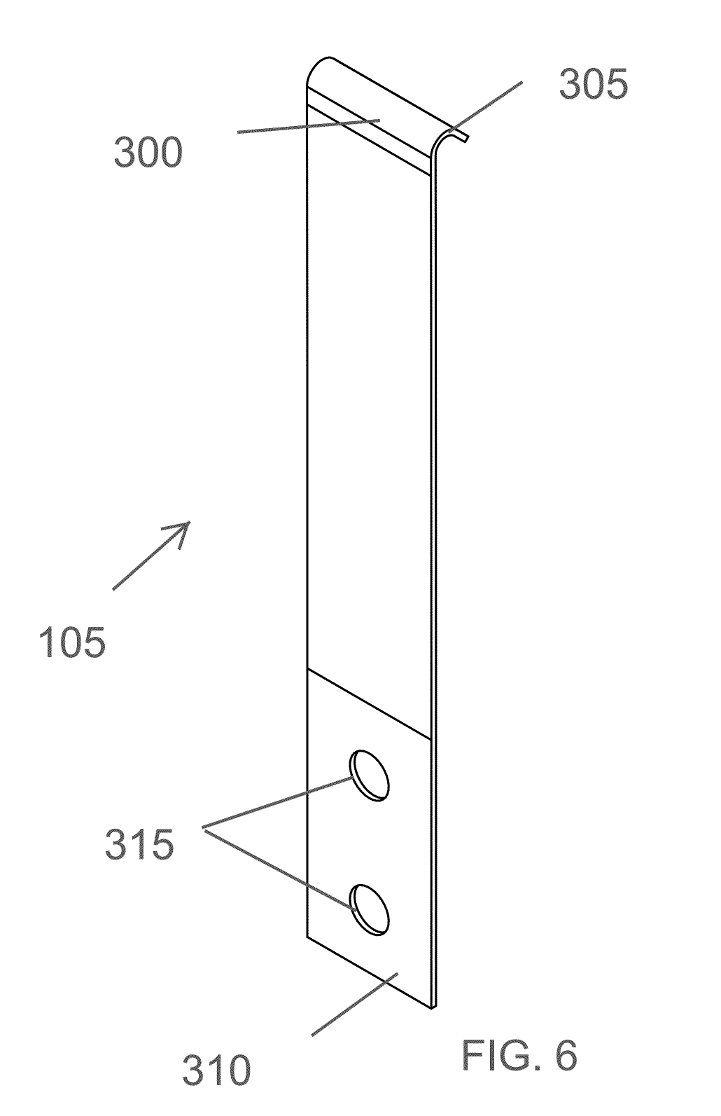

Referring to FIGS. 5 and 6, the upper pawl 85 (FIG. 5) comprises a bracket 270 defining a through bore 275 and an outwardly-directed tooth 280 at opposite ends 285 and 290 thereof, and a spring housing 295 located between the tooth and through bore. A first end 300 of the upper pawl spring 105 (FIG. 6) is defines a hook 305 that interferingly contacts the upper pawl's spring housing 295 while a second end 310 of the spring defines one or more bores 315 adapted to affix the spring's second end to the interior portion 160 of the release mechanism 75 to bias the tooth 280 of the upper pawl against the arcuate toothed surface 55 of the lower jaw 50. While it is understood that bolts, screws, rivets, plastic flange or any other fastening method may be utilized to affix the spring's second end 310 to the release mechanism 75 via the one or more bores, it is further understood that other fastening method known in the art may be utilized to affix the ends of the upper spring to the respective foregoing components as well.

Referring again to FIGS. 1 and 2, the through bore 275 of the upper pawl 85 is axially aligned with the second through bore 40 of the upper body and pin 320 is inserted there-though such that the upper body and upper pawl are pivotally connected to one another. While FIG. 1 illustrates the upper pawl spring 105 as a leaf spring, it is understood that the upper pawl spring may comprise a coil spring or any other spring as well. The lower jaw's through bore 67 is axially aligned with the upper body's first through bore 35 such that the lower jaw 50 and upper body 10 are pivotally connected to the one another via the insertion of a pin 325 through the respective through bores, Likewise, the adjustment mechanism's linkage adjuster tail bore 170 or 170a (FIG. 4 or 4a) is axially aligned with the upper body's third through bore 45 such that the adjustment mechanism 80 and upper body 10 are pivotally connected to the one another via the insertion of a pin 330 through the respective through bores. A first end 335 of the jaw release spring 94 contacts the upper jaw 15 of the upper body 10 while a second end 340 of the spring contacts the lower jaw 50 to bias the upper and lower jaws away from one another. While FIG. 1 illustrates the jaw release spring 94 as a coil spring, it is understood that the jaw release spring may comprise a torsion spring or any other spring as well.

In operation, the pliers are gripped in one's hand and the lower handle is drawn towards the upper handle. Upon drawing the lower handle towards the upper handle, the lower handle is pivoted about its pin via its second bore to cause the forward end of the member to move downwardly. The downward movement of the lower handle's forward end also results in a downward movement of the lower pawl, which is pivotally connected to the lower handle's forward end and spring biased to engage the lower jaw. During the downward movement of the lower pawl, the lower pawl spring biases the lower pawl's teeth to engage the lower jaw's arcuate surface, thus causing the lower jaw to pivot about its pin via its bore and resulting in an upward movement of the lower jaw towards the upper jaw.

Because the lower handle is spring biased away from the upper handle by the lower handle spring, a release of the lower handle will cause the lower handle to pivot in an opposite direction such that its forward end moves upwardly. The upward movement of the lower handle's forward end also results in an upward movement of the lower pawl, which is pivotally connected to the lower handle's forward end. During the upward movement of the lower pawl, the lower pawl's teeth disengage from the lower jaw's arcuate surface via a coaction of the pawl's engagement pins with the lower jaw's engagement grooves. The coaction of the pins with the grooves causes the lower pawl to pivot about its axis, thus rotating the pawl's teeth away from the toothed surface of the lower jaw. However, the lower jaw does not pivot away from the upper jaw because it is held in place via the spring-biased engagement of the upper pawl's tooth with the lower jaw's arcuate toothed surface.

A rotation of the linkage thumbnut of the adjustment mechanism facilitates an adjustment of the clamping pressure and locking function of the upper and lower jaws. The linkage thumbnut's inner thread is engaged with the linkage adjuster's outer thread such that the rotation of the linkage thumbnut increases or decreases the axial distance defined between the thumbnut pivot's pivot bore and the linkage adjuster's tail bore. An increase or decrease of this axial distance of the adjustment mechanism changes the pivot position of the lower handle in relation to the upper and lower jaws, thus facilitating their clamping pressure adjustment and locking function.

Upon drawing the handle release mechanism towards the upper handle, the second end of the upper pawl spring is moved rearwardly to cause the upper pawl to pivot about its pin, via the upper member's second bore, thus causing the pawl's tooth to rotate away from engagement with the lower jaw's arcuate toothed surface. The lower jaw thus pivots away from the upper jaw under the influence of the lower spring jaw located between the lower and upper jaws.

While this foregoing description and accompanying figures are illustrative of the present invention, other variations in structure and method are possible without departing from the invention's spirit and scope. For example, the adjustment mechanism may comprise a screw-driven mechanism located within the upper handle of the upper member and operably associated with the lower handle.

We claim:

1. A pliers comprising:
a lower handle;
a release mechanism and lower pawl operably associated with the lower handle;
an upper pawl operably associated with the release mechanism;
a lower jaw operably associated with the upper and lower pawls; and
an upper body defining an upper handle and upper jaw, the upper jaw operably associated with the lower jaw and the upper handle operably associated with the lower handle.

2. The pliers of claim 1 further comprising an adjustment mechanism adjustably operably associating the upper body and lower handle.

3. The pliers of claim 2 wherein the adjustment mechanism facilitates an adjustment of a clamping pressure between the upper and lower jaws.

4. The pliers of claim 1 wherein the lower jaw defines a toothed arcuate outer surface, the surface operably associated with the upper and lower pawls.

5. The pliers of claim 2 wherein the adjustment mechanism comprises a thumbnut pivot and linkage adjuster, the pivot operably associated with the release mechanism, lower handle and linkage thumbnut, the adjuster operably associated with the upper body and linkage thumbnut.

6. The pliers of claim 1 wherein the lower pawl defines a pair of inwardly directed pins and the lower jaw defines a pair of arcuate grooves, the pins of the pawl operably associated with the grooves of the jaw.

7. The pliers of claim 5 wherein a rotation of the linkage thumbnut changes a pivot position of the lower handle in relation to the upper and lower jaws.
